(19) United States
(12) Patent Application Publication
(10) Pub. No.: US 2005/0049873 A1
(43) Pub. Date: Mar. 3, 2005

(54) Dynamic ranges for viterbi calculations

(76) Inventors: Itamar Bartur, Rehovot (IL); Amir Globerson, Rehovot (IL); Tal El-Hay, Jerusalem (IL); Tal Yadid, Ramat Hasharon (IL)

Correspondence Address: DANIEL J SWIRSKY, PO BOX 2345, BEIT SHEMESH, 99544, IL

(21) Appl. No.: 10/650,040

(22) Filed: Aug. 28, 2003

(51) Int. Cl. G10L 15/14

(52) U.S. Cl. 704/256

(57) ABSTRACT

A method of recognizing speech includes determining active ranges of states to be processed for each frame and performing recognition operations for each frame only on states within the active ranges.

### FIELD OF THE INVENTION

The present invention relates to speech recognition generally and to Viterbi calculations forming part of the hidden Markov model type of speech recognition in particular.

### BACKGROUND OF THE INVENTION

Common speech recognition systems employ probabilistic models known as hidden Markov models (HMMs). A hidden Markov model includes a plurality of states, wherein a transition probability is defined for each transition from each state to every state, including transitions to the same state. A common type of HMM used for speech recognition is a left-to-right HMM, which defines that a given state depends only on itself and on previous states (i.e. there are no backward state transitions).

An observation is probabilistically associated with each unique state. The transition probabilities between states are not (necessarily) all the same. A search technique, such as a Viterbi algorithm, is employed in order to determine the most likely state sequence for which the joint probability of the observation and state sequence, given the specific HMM parameters, is maximum. One explanation of the HMM method and the Viterbi search is provided in the book Spoken Language Processing: A Guide to Theory, Algorithm, and System Development, by Huang et al., Prentice Hall, 2001, pages 377-389 and 622-627.

A sequence of state transitions can be represented, in a known manner, as a path through a trellis diagram that represents all of the states of the HMM over a sequence of observation times. Therefore, given an observation sequence, a most likely path through the trellis diagram (i.e., the most likely sequence of states represented by an HMM) can be determined using the Viterbi algorithm.

In speech recognition systems, speech can be viewed as being generated by a hidden Markov process. Consequently, HMMs have been employed to model observed sequences of speech spectra, where specific spectra are probabilistically associated with a state in an HMM. In other words, for a given observed sequence of speech spectra, there is a most likely sequence of states in a corresponding HMM.

This corresponding HMM is thus associated with the observed sequence. This technique can be extended, such that if each distinct sequence of states in the HMM is associated with a sub-word unit, such as a phoneme, then a most likely sequence of sub-word units can be found. Moreover, using models of how sub-word units are combined to form words, and then using language models of how words are combined to form sentences, complete speech recognition can be achieved.

When actually processing an acoustic input signal, the input signal is typically sampled in sequential time intervals called frames. The frames typically include a plurality of samples and may overlap or be contiguous. Each frame is associated with a unique portion of the speech signal. The portion of the speech signal represented by each frame is analyzed for features and these features are extracted to provide a corresponding feature vector. During speech recognition, a search is performed for the state sequence most likely to be associated with the sequence of feature vectors.

In order to find the most likely sequence of states corresponding to a sequence of feature vectors, an HMM model is accessed and the Viterbi algorithm is employed. The Viterbi algorithm performs a computation which starts at the first frame and proceeds one frame at a time, in a time-synchronous manner. A probability score is computed for each state in the state sequences (i.e., the HMMs) being considered. Therefore, for each state, the Viterbi algorithm successively computes a cumulative probability score for the most likely state sequences that end at the current state and that generated the sequence of observations until the present time frame. By the end of an utterance, the state sequence (or HMM or series of HMMs) having the highest probability score computed by the Viterbi algorithm provides the most likely state sequence for the entire utterance. The most likely state sequence is then converted into a corresponding spoken subword unit, word, or word sequence.

The Viterbi algorithm reduces an exponential computation to one that is proportional to the number of states and transitions in the model and the length of the utterance. However, for a large vocabulary, the number of states and transitions becomes large. Thus, a technique called pruning, or beam searching, has been developed to greatly reduce the computation needed to determine the most likely state sequence. This type of technique eliminates the need to compute the probability score for state sequences that are very unlikely. This is typically accomplished by comparing, at each frame, the probability score for each state sequence (or potential sequence) under consideration with the cumulative probability for the state sequence that ended at that state, for the current time frame. If the probability score of a state for a particular potential sequence is sufficiently low (when compared to the maximum computed probability score for the other potential sequences at that point in time), the pruning algorithm assumes that it will be unlikely that such a low scoring state sequence will be part of the completed, most likely state sequence. The comparison is typically accomplished using a minimum threshold value. Potential state sequences having a score that falls below the minimum threshold value are defined as currently “inactive”. The threshold value can be set at any desired level, based primarily on desired memory and computational savings, and a desired error rate increase caused by memory and computational savings. An inactive state is not taken for Viterbi calculations in the next frame, although it is possible that an inactive state may return to activity in a future calculation if the states upon which it depends have significant activity.

An alternative pruning method is to fix the number of states N to be processed. For example, N might be 300. In this method, at each time frame, the N best-score states are set as active, and the rest are set to be inactive.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is block diagram illustration of an active range speech recognition system, constructed and operative in accordance with the present invention;

FIG. 2 is a block diagram illustration of an active range speech recognizer, useful in the system of FIG. 1;

FIG. 3 is a schematic illustration of three types of buffers used in the recognizer of FIG. 2;

FIG. 4 is a pseudo-code illustration of an exemplary active range Viterbi unit, useful in the recognizer of FIG. 2;

FIG. 5 is a pseudo-code illustration of an exemplary active range pruner, useful in the recognizer of FIG. 2; and

FIGS. 6 and 7 are pseudo-code illustrations of two exemplary active range updaters, useful in the recognizer of FIG. 2.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that, while the pruning process may significantly increase the speed of the Viterbi algorithm, the algorithm may still need improvement. In particular, in some implementations, the recognizer may both check the inactive/active status of a state and process the state only if it is active. Applicants have realized that this checking takes time, particularly at the later stages of the algorithm when many of the states have ceased to be active.

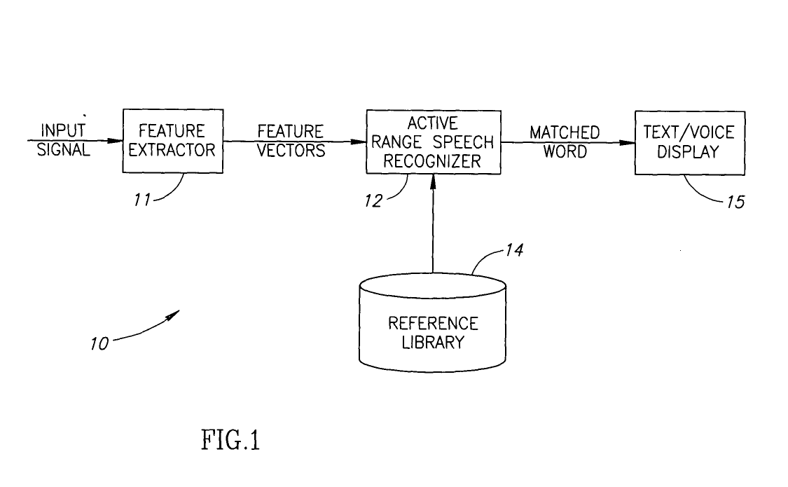

Reference is now made to FIG. 1, which generally illustrates a speech recognition system 10, constructed and operative in accordance with a preferred embodiment of the present invention. System 10 may comprise a feature extractor 11, a speech recognizer 12, a reference library 14 and a display 15.

As is known in the art, feature extractor 11 may take an input speech signal to be recognized and may process it in any appropriate way to generate feature vectors. One common way is to digitize the signal and segment it into frames. For each frame, feature vectors may be found. Any type of feature vectors may be suitable; the only condition is that the reference library 14 store reference models which are based on the same type of feature vectors.

The reference models in reference library 14 may be hidden Markov models (HMMs) of words to be recognized. Each HMM may have multiple states; any type of HMM may be possible and is incorporated in the present invention. Each state may have data associated therewith. For example, some systems may have two-state HMMs, where each state has four probability functions associated therewith. For example, the probability functions might be Gaussians, but other types of probability functions are also included in the present invention.

Active range speech recognizer 12 may match the feature vectors of the input speech signal with the HMM models in reference library 14 and may determine which word in reference library 14 was spoken. As will be described in more detail hereinbelow, active range speech recognizer 12 may use per word, “active ranges” to determine which states of reference library 14 to use for recognition calculations at each frame. Any states outside of the active ranges may not be processed in any way at that time frame. As described in more detail hereinbelow, there may be one, or more ranges per reference word and thus, a limited number of checks may be made to determine which states are to be processed for each word.

Display 15 may display the matched word, either textually or audibly.

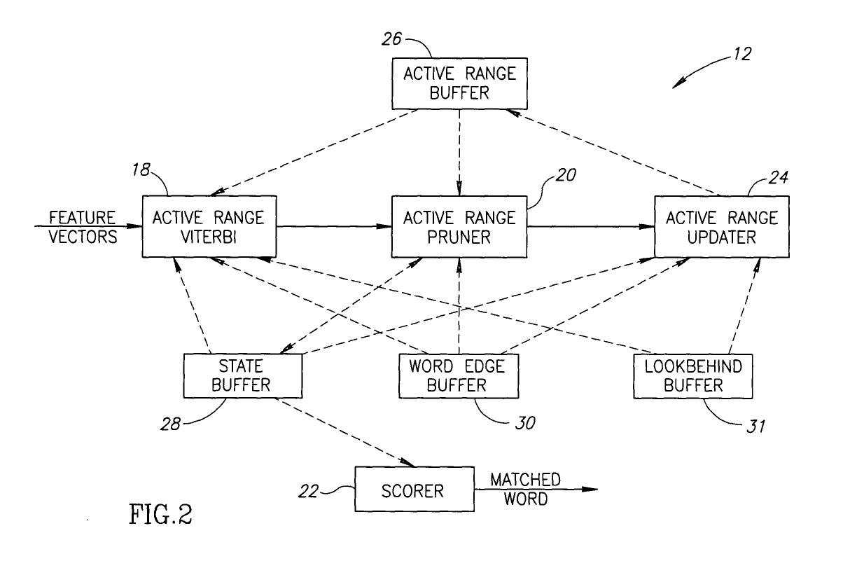

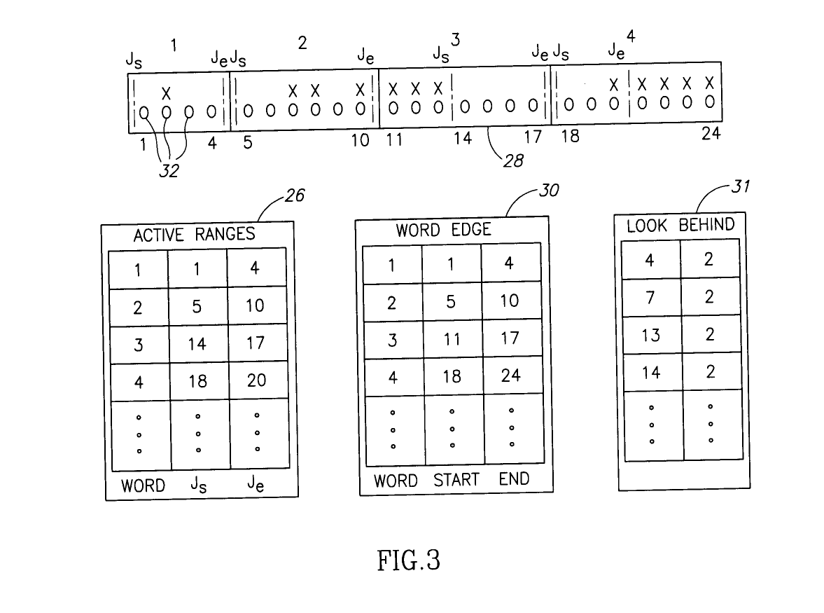

Reference is now made to FIG. 2, which illustrates active range speech recognizer 12, and to FIG. 3, which illustrates three buffers used in recognizer 12. Active range speech recognizer 12 may comprise an active range Viterbi calculator 18, an active range pruner 20, a scorer 22 and an active range updater 24. It may also comprise an active range buffer 26, a state buffer 28, a word edge buffer 30 and a lookbehind buffer 31.

State buffer 28 may store the states of the reference words to be matched to the input signal in a fixed order. State buffer 28 may also store the active/inactive status of each state. In FIG. 3, four exemplary reference words 1, 2, 3 and 4 are shown; it will be appreciated that many more words are typically stored and such is incorporated within the present invention. In accordance with a preferred embodiment of the present invention, the reference words are modeled with left-to-right HMMs.

Each word may have a multiplicity of states 32 and the words may be stored one after another. As stored in word edge buffer 30, in the example of FIG. 3, states 1 to 4 may belong to word 1, states 5 through 10 may belong to word 2, states 11 through 17 may belong to word 3 and states 18 through 24 may belong to word 4.

In FIG. 3, some of the states in buffer 28 have been marked with an X as being inactive. In word 1, the second state is inactive, in word 2, the third, fourth and sixth states are inactive, in word 3, the first-third states are inactive and in word 4, the only the first two states are active. The remaining states are inactive.

In accordance with an embodiment of the present invention, active range buffer 26 may store, per reference word, the current range of states which are to be processed during the current calculation period. The current range may be defined as having a start state jₛ and an end state jₑ. Buffer 26 may store start state jₛ and end state jₑ for each word.

There may be one active range per word, in which case, it may include at least all of the active states of the reference word. It may include some inactive states if they are between active states and it may include states that may become active in the current frame. The active states and the states which may become active together will be called “to be processed” states. The remaining states will be called “not to be processed” states.

It will be appreciated that there may be more than one active range per word.

In the example of FIG. 3, there is one active range per word. For word 4, the active range may be from state 18 to state 20, which are the first through the third states of word 4. States 18 and 19 are still active and thus, may be included within the active range. Of the inactive states (20-24), only those, like state 20, whose Viterbi calculations depend on one or more active states may also be included. Any other inactive state cannot become active, in the current time frame, since the states it depends on are also inactive.

How large a “lookbehind” there may be may depend on the type of hidden Markov model used by speech recognizer 12. For example, a two-state HMM models each sub-unit (typically a phoneme) of a word with two states. Each state depends on itself and on the state previous to it (i.e. a lookbehind of 1). A three-state HMM might depend on itself, the state previous to it and the state previous to that state. (i.e. a lookbehind of 2). As will be appreciated, the size of the lookbehind may vary. It may be the same for all states in a word or it may vary within a word as well. Lookbehind buffer 31 may store the lookbehind values for each state or may store only those states whose lookbehind values may be greater than 1.

Returning to the active range calculations, state 20 (the third state of word 4) may be included within the active range of word 4 since it has a lookbehind of 1 and thus, its calculations depend on itself and on the value of active state 19. States 21-24, which also have a lookbehind of 1, may not be included since their lookbehind states (20-23, respectively) are all inactive and there are no active states which follow them.

For word 3, the first three states (states 11-13) are inactive while the remaining four states are active. In accordance with one preferred embodiment of the present invention, the start state jₛ may be defined by finding the first state from the beginning of the word which is active. Thus, for word 3, start state jₛ is state 14. The end state jₑ may be defined by finding the first state from the end of the word which either is active or has an active state within its lookbehind range. Thus, for word 3, the last state listed in word edge buffer 30 is state 17. This state is active and thus, end state jₑ is set to state 17.

For word 2, the inactive states are state 7, 8 and 10. However, the first state of word 2, state 5, is active, so the active range begins at state 5. The last state, state 10, is not active, but the state before it is. Because of the addition of the default lookbehind value of 1, the active range for word 2 is set to be state 10. Thus, despite having some inactive states, all states of word 2 remain within the active range. Similarly, even though word 1 has one inactive state (state 2), all the states of the word are placed into the active range.

Other methods of defining the active range may exist and are incorporated into the present invention. For example, a word may have multiple active ranges. In another example, described in more detail hereinbelow with respect to FIGS. 7 and 8, new ranges may be determined by starting from the previous range and moving about the edges of the old range to determine the edges of the new range. In another embodiment, reference words may be formed into clusters and at least some of the ranges may be “per cluster” rather than per word. In a further embodiment, the active range may not be per word but per areas in the state buffer 28 which are active. In this embodiment, the borders between words may be ignored.

Returning to FIG. 2, for each frame, active range Viterbi calculator 18 may process only those states within the active range or ranges stored in active range buffer 26.

Active range Viterbi calculator 18 may access active range buffer 26 to determine the current active range to be processed, may access state buffer 28 to retrieve the states within the current active range and may perform the Viterbi calculations on all states within the active range. In addition, Viterbi calculator 18 may access lookbehind buffer 31 for a listing of those states whose lookbehinds are greater than 1.

After Viterbi calculator 18 has finished operating on all active ranges, active range pruner 20 may prune any not sufficiently active states within the currently defined active ranges. Active range updater 24 may review the states in state buffer 30 and may update the active range for each reference word, or for each cluster of words or for any other group of states, as defined by the designer, storing the new results in active range buffer 26. The resultant new ranges may be utilized for the next time frame.

Once Viterbi calculator 18 may have finished its operations, scorer 22 may review the scores for each reference word and may determine which reference word matched the input signal.

It will be appreciated that speech recognizer 12 may provide increased speed over prior art recognizers since active range Viterbi unit 18 and active range pruner 20 operate only the states within the active ranges. Although the calculations performed on each state being processed may be the same or similar to those in the prior art, active range Viterbi unit 18 and active range pruner 20 only process a portion of the states (i.e. only those within the active ranges).

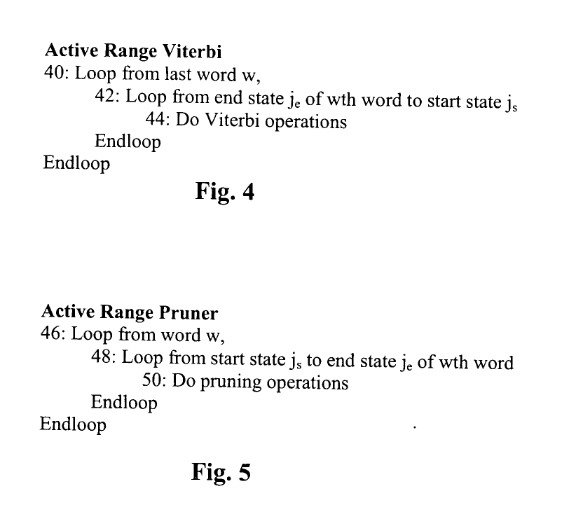

Reference is now made to FIGS. 4, 5 and 6, which illustrates, in pseudo-code format, one exemplary method which may be performed by active range Viterbi unit 18, active range pruner 20 and active range updater 24, respectively, using buffers 26, 28, 30 and 31. The exemplary method of FIGS. 4, 5 and 6 may produce one active range per reference word.

For each frame t, the calculations may be performed. Active range Viterbi unit 18 may loop (step 40 (FIG. 4)) over each word w, starting from the last word. In accordance with a preferred embodiment of the present invention, unit 18 may loop (step 42) from end state jₑ to start state jₛ and may perform (step 44) the Viterbi operations for the active states within the loop.

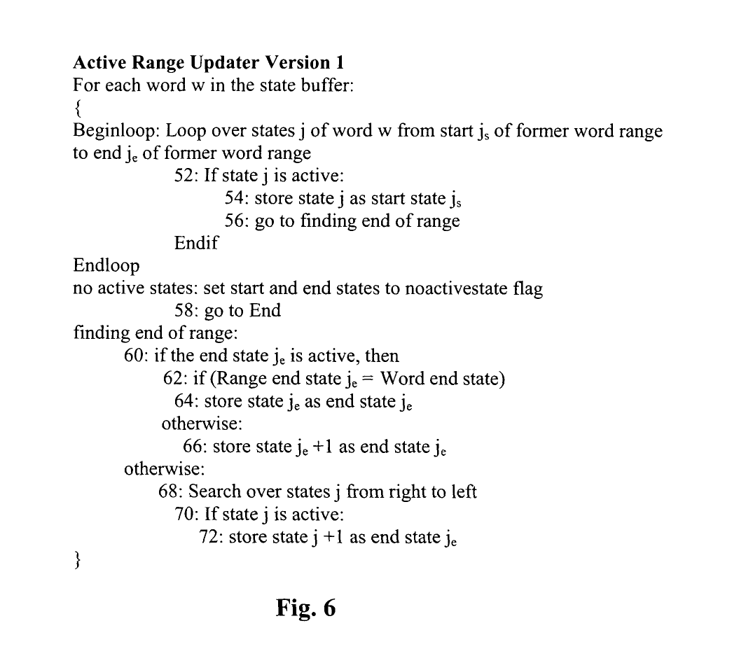

Pruner 20 may also loop (step 46 (FIG. 5)) for each word w and may loop (step 48) from start state jₛ to end state jₑ, performing pruning operations (step 50) for any state within the active range jₛ to jₑ. Any suitable pruning method may be used such that states which are no longer to be considered active are suitably marked.

With the states for frame t marked as active or inactive, active range updater 24 (FIG. 2) may determine the new active ranges for each word w, to be used for the next frame, t+1. Active range updater 24 may update the values in active range buffer 26. Recognizer 12 may then repeat the process for the next time frame, t+1, using the newly determined active ranges. Recognizer 12 may continue until there are no more frames t after which, scorer 22 may determine the matched reference word.

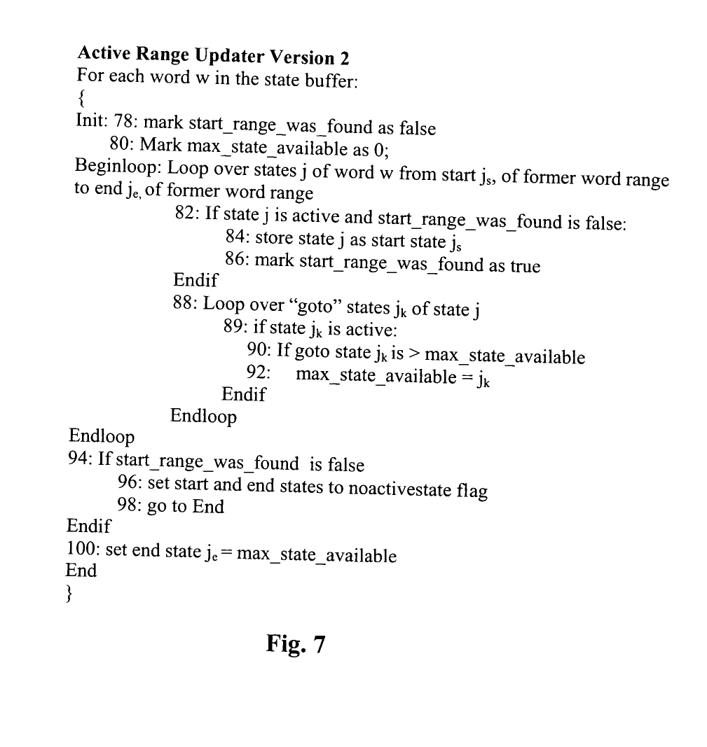

FIG. 6 details the operations of one exemplary active range updater 24. The updater 24 of FIG. 6 assumes that each state has only one lookbehind state.

In the loop labeled “beginloop”, active range updater 24 may loop over the states j of the current word w, from the current start state jₛ to the current end state jₑ, where the range of states of current word w may be listed in word edge buffer 30 (FIG. 2). If the state j is active (as checked in step 52), active range updater 24 may store (step 54) state j as the start state jₛ and may skip (step 56) to the step labeled “endstateloop” to find the end state jₑ.

Should active range updater 24 not find any active states within word w, active range updater 24 may arrive at the section labeled “noactivestates”, in which case, updater 24 may set start state jₛ and end state jₑ to a noactivestate flag (such as 0) and then it may stop operation (step 58).

In endstateloop, active range updater 24 may loop over the states of word w from the end of the word. If end state jₑ is active (as checked in step 60), active range updater 24 may check (step 62) if end state jₑ is the last state of the word by checking word edge buffer 30. If it is the last state of the word, then active range updater 24 may not change end state jₑ (see step 64). However, if end state jₑ is a state in the middle of the word, then, since it is an active state, active range updater 24 may set (step 66) the next end state jₑ to the next state to the right (i.e. jₑ+1).

If end state jₑ is inactive, then active range updater 24 may search over the states j from the end (i.e. from right to left), looking (step 72) for the first active state j. Active range updater 24 may then set (step 74) end state jₑ to state j+1, the state to the right of the first active state j.

To begin the operation, recognizer 12 may initialize all states as being “not yet active” and may set the start and end state of each word as being at the first and second states of each word, respectively. Viterbi unit 18 and pruner 20 may then process the states within the active range of each word. As can be seen from FIG. 6, when updater 24 may determine the next active range, it may move end state jₑ to the right. Thus, the range may initially expand until such time as states within a word or words become inactive.

Reference is now made to FIG. 7, which illustrates an alternative embodiment of active range updater 24 where each state may have a varying lookbehind value. This embodiment may utilize a “goto/comefrom” buffer (not shown) which organizes the states in topological order. Each state has the states it comes (“comefrom” states) from on its left and the states it goes to (“goto” states) on its right. Such a topological buffer is known as a directed acyclic graph (DAG) and is commonly found in speech recognition systems.

Active range updater 24 of FIG. 7 may start by initializing two variables: “start_range_was_found” and “max_state_available”. Updater 24 may set (step 78) the variable start_range_was_found to false (it will be made true when start state jₛ is found). Updater 24 may set (step 80) the variable max_state_available to 0 (it will change as the rightmost state is found).

In the loop labeled “beginloop”, active range updater 24 may loop over the states j of the current word w, from the current start state jₛ, to the current end state jₑ, where the range of states of current word w may be listed in word edge buffer 30 (FIG. 2). If the state j is active and the variable start_range_was_found is false (as checked in step 82), active range updater 24 may store (step 84) state j as the start state jₛ, and may set (step 86) the variable start_range_was_found as true.

Active range updater 24 may then loop (step 88) over the “goto” states jₖ of state j. If goto state jₖ is active (as checked in step 89), then active range updater 24 may check (step 90) whether or not goto state jₖ is larger than (or more to the right than) the state currently listed in the variable max_state_available. If goto state jₖ is larger, then active range updater 24 may set (step 92) the variable max_state_available to goto state jₖ.

When beginloop finishes, active range updater 24 may check the variables start_range_was_found and max_state_available. In step 94, updater 24 may check if the variable start_range_was_found is false. If it is, then, in step 96, updater 24 may set (step 96) start state jₛ and end state jₑ to a noactivestate flag (such as 0) and then it may stop operation (step 98).

In step 100, active range updater 24 may set end state jₑ to the value stored in max_state_available.

It will be appreciated that the “pass” over the states may be done in active range pruner 20 since pruner 20 also reviews the states.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A speech recognition system comprising:
a reference library to store a plurality of reference words, each having a multiplicity of states; and
a speech recognizer to match an input signal to one of said plurality of reference words, said speech recognizer having an active range storage unit to store a multiplicity of active ranges defining said states on whom recognition operations are to be performed for a current frame.

2. A system according to claim 1 and having at least one active range per reference word.

3. A system according to claim 2 and wherein each said active range has a start state and an end state and wherein said start state is the first state to be processed in said word for said current frame and said end state is the last state to be processed in said current frame.

4. A system according to claim 2 and wherein each said active range minimally comprises the active states within said reference word.

5. A system according to claim 4 and wherein each said active range also comprises at least one inactive state not able to become active in said current frame.

6. A system according to claim 1 and wherein said speech recognizer comprises an active range updater to determine the beginning and end of each of said active ranges.

7. A system according to claim 1 and wherein said speech recognizer comprises an active range Viterbi calculator and an active range pruner to process states within said active ranges.

8. A system according to claim 1 and comprising a state buffer storing all of said states in a fixed order and their active/inactive status.

9. A speech recognition system comprising:
a reference library to store a plurality of reference words, each having a multiplicity of states; and
a speech recognizer to match an input signal to one of said plurality of reference words, said speech recognizer to determine a multiplicity of active ranges defining states to be processed for each frame and to perform recognition operations for said frame only on states within said active ranges.

10. A system according to claim 9 and having at least one active range per reference word.

11. A system according to claim 10 and wherein each said active range has a start state and an end state and wherein said start state is the first state to be processed in said word for said current frame and said end state is the last state to be processed in said current frame.

12. A system according to claim 10 and wherein each said active range minimally comprises the active states within said reference word.

13. A system according to claim 12 and wherein each said active range also comprises at least one inactive state not able to become active in said current frame.

14. A system according to claim 9 and wherein said speech recognizer comprises an active range updater to determine the beginning and end of each of said active ranges.

15. A system according to claim 9 and wherein said speech recognizer comprises an active range Viterbi calculator and an active range pruner to process states within said active ranges.

16. A system according to claim 9 and comprising a state buffer storing all of said states in a fixed order and their active/inactive status.

17. An active range Viterbi calculator comprising:
means for retrieving active ranges for a current frame; and
means for performing Viterbi calculations only on states within said active ranges.

18. A system according to claim 17 and having at least one active range per reference word.

19. A system according to claim 18 and wherein each said active range has a start state and an end state and wherein said start state is the first state to be processed in said word for said current frame and said end state is the last state to be processed in said current frame.

20. A system according to claim 18 and wherein each said active range minimally comprises the active states within said reference word.

21. A system according to claim 20 and also comprising at least one inactive state not able to become active in said current frame.

22. An active range pruner comprising:
means for retrieving active ranges for a current frame; and
means for performing pruning operations only on states within said active ranges.

23. A system according to claim 22 and having at least one active range per reference word.

24. A system according to claim 23 and wherein each said active range has a start state and an end state and wherein said start state is the first state to be processed in said word for said current frame and said end state is the last state to be processed in said current frame.

25. A system according to claim 23 and wherein each said active range minimally comprises the active states within said reference word.

26. A system according to claim 25 and also comprising at least one inactive state not able to become active in said current frame.

27. A data structure for a speech recognition system, the data structure comprising:
a multiplicity of active ranges, each active range defining states to be processed in a current frame and each active range comprising:
a beginning state of said active range, wherein said beginning state is the first active state; and
an end state of said active range, where said end state is the last state able to become active in said current frame.

28. A system according to claim 27 and having at least one active range per reference word.

29. A system according to claim 28 and wherein each said active range minimally comprises the active states within said reference word.

30. A system according to claim 29 and also comprising at least one inactive state not able to become active in said current frame.

31. A method of recognizing speech, the method comprising:
determining active ranges for each frame to be processed; and
performing recognition operations for each said frame only on states within said active ranges.

32. A method according to claim 31 and having at least one active range per reference word.

33. A method according to claim 32 and wherein each said active range has a start state and an end state and wherein said start state is the first state to be processed in said word for said current frame and said end state is the last state able to be processed in said current frame.

34. A method according to claim 32 and wherein each said active range minimally comprises the active states within said reference word.

35. A method according to claim 34 and also comprising at least one inactive state not able to become active in said current frame.

36. A method according to claim 31 and said determining comprises determining the beginning and end of each of said active ranges.

37. A method according to claim 31 and wherein said performing comprises performing Viterbi calculations.

38. A method according to claim 37 and wherein said performing comprises reviewing the output of said performing Viterbi calculations and marking states within said active ranges as active or inactive.

39. A method according to claim 31 and comprising storing all of said states in a fixed order and their active/inactive status.
